(19) United States
(12) Patent Application Publication
(10) Pub. No.: US 2026/0323163 A1
(43) Pub. Date: Oct. 15, 2026

(54) REFLECTION MODULE AND CAMERA MODULE INCLUDING THE SAME

(71) Applicant: Samsung Electro-Mechanics Co., Ltd., Suwon-si (KR)

(72) Inventors: Jong Woo HONG, Suwon-si (KR); Young Hwan KWON, Suwon-si (KR); Hong Joo LEE, Suwon-si (KR); Nam Ki PARK, Suwon-si (KR); Jae Hyung HAN, Suwon-si (KR); Hyun Jun KIM, Suwon-si (KR)

(73) Assignee: Samsung Electro-Mechanics Co., Ltd., Suwon-si (KR)

(21) Appl. No.: 19/530,463

(22) Filed: Feb. 5, 2026

(30) Foreign Application Priority Data
Apr. 15, 2025 (KR) 10-2025-0049100
Jul. 17, 2025 (KR) 10-2025-0096949

(51) Int. Cl. H04N 23/68; G03B 5/00; H04N 23/51; H04N 23/55

(52) U.S. Cl. CPC H04N 23/685; G03B 5/00; H04N 23/51; H04N 23/55; G03B 2205/0007; G03B 2205/0069

(57) ABSTRACT

A reflection module is provided. The reflection module includes a housing; a guide member, disposed on the housing, and configured to rotate about a first rotation axis; a holder including a reflective member and configured to rotate, with respect to the guide member, about a second rotation axis, perpendicular to the first rotation axis; a first driving unit including a first magnet disposed on the holder and a first coil disposed on the housing to face the first magnet; and at least one pair of first position sensors disposed on one surface of the housing, wherein the first position sensors of the pair of first position sensors are disposed symmetrically with respect to a center of the first coil.

### CROSS-REFERENCE TO RELATED APPLICATIONS

This application claims the benefit under 35 USC 119(a) of Korean Patent Application Nos. 10-2025-0049100 filed on Apr. 15, 2025, and 10-2025-0096949 filed on Jul. 17, 2025, in the Korean Intellectual Property Office, the entire disclosures of which are incorporated herein by reference for all purposes.

### BACKGROUND

### 1. Field

The following description relates to a reflection module and a camera module including the same.

### 2. Description of Related Art

Camera modules in which a reflective member is disposed in front of a lens module to bend an optical propagation path has been implemented in mobile devices.

Such a type of camera module may perform optical image stabilization (OIS) operations during image capturing by rotating the reflective member about two axes, perpendicular to each other.

Therefore, it is desirous that precise sensing of a position of the reflective member is performed in advance in order to perform an accurate OIS operation, and to improve the resolution of an image.

When a rotation axis of the reflective member and a position of a sensor are misaligned, a sensing error may also increase as a stroke angle increases, which results in a demand for a structure that reduces the sensing error.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflection module includes a housing; a guide member, disposed on the housing, and configured to rotate about a first rotation axis; a holder, including a reflective member, and configured to rotate, with respect to the guide member, about a second rotation axis, perpendicular to the first rotation axis; a first driving unit including a first magnet disposed on the holder and a first coil disposed on the housing to face the first magnet; and at least one pair of first position sensors disposed on one surface of the housing, wherein the position sensors of the at least one pair of first position sensors are disposed symmetrically with respect to a center of the first coil.

The at least one pair of first position sensors may be disposed in a direction parallel to the first rotation axis.

Each of the at least one pair of position sensors may be disposed to be spaced apart from the center of the first coil in the direction parallel to the first rotation axis.

Based on an imaginary plane perpendicular to the first rotation axis and including the second rotation axis, a number of first position sensors facing a first side of the imaginary plane may be equal to a number of first position sensors facing a second side of the imaginary plane among the at least one pair of position sensors.

A distance between the first position sensor facing the first side of the imaginary plane and the imaginary plane may be equal to a distance between the first position sensors facing the second side of the imaginary plane and the imaginary plane.

The reflection module may further include at least one pair of first sensing magnets disposed on the holder, and the at least one pair of first sensing magnets may face the at least one pair of first position sensors.

A first position sensing unit, which includes the first position sensors and the first sensing magnets, may be configured to sum sensing results received from the respective first position sensors.

Each of the first magnet of the first driving unit and the first sensing magnet may have two polarities disposed in a direction parallel to the first rotation axis, and a region where the first magnet of the first driving unit and the first sensing magnet face each other may have a same polarity.

The at least one pair of first position sensors may be disposed in a direction parallel to the second rotation axis.

An imaginary plane perpendicular to the first rotation axis and including the second rotation axis may pass through the at least one pair of first position sensors.

The reflection module may include a first ball member disposed between the holder and the guide member and including a plurality of balls that are spaced apart from each other along the second rotation axis.

The reflection module may further include a second driving unit including second magnets respectively disposed on respective side surfaces of the guide member and second coils disposed on the housing to face the second magnets, wherein the respective side surfaces of the guide member may be perpendicular to the second rotation axis.

The reflection module may further include a second ball member disposed between the guide member and the housing, the second ball member including a center ball that forms the first rotation axis and guide balls that supports the guide member.

In a general aspect, a camera module includes a holder on which a reflective member is mounted; a guide member on which the holder is disposed and which is configured to rotate, together with the holder, about a first rotation axis; a housing which accommodates the holder and the guide member; a lens module through which light reflected from the reflective member passes in an optical axis direction; a first driving unit including a first magnet mounted on the holder and a first coil which faces the first magnet in the optical axis direction; and at least one pair of first position sensors disposed on one surface of the housing, wherein the holder is configured to rotate, relative to the guide member, about a second rotation axis, perpendicular to the first rotation axis, and wherein the first position sensors of the pair of first position sensors are disposed symmetrically with respect to an imaginary center line which extends along an optical axis.

Each of the first position sensors may be disposed to be spaced apart from the imaginary center line in a direction parallel to the first rotation axis.

A shortest distance between each of the first position sensors and the imaginary center line may be equal to each other.

In a general aspect, a camera module includes a housing; a guide member, disposed on the housing, and configured to rotate about a first axis; a holder, including a reflective member, and configured to rotate, with respect to the guide member, about a second axis perpendicular to the first axis; and a first position sensing unit configured to detect a rotation of the holder, wherein the first position sensing unit includes: a plurality of first sensing magnets disposed on a surface of the holder which faces the housing in a first axis direction, and a plurality of first position sensors disposed on the housing to respectively face the plurality of first sensing magnets.

At least one of the plurality of first sensing magnets may include a combination of a pair of unipolar magnets which have different polarities.

The plurality of first sensing magnets may be aligned along a third axis which is perpendicular to the first axis and the second axis, and disposed symmetrically with respect to the second axis.

The holder may include a protrusion which extends toward the guide member in the first axis direction, wherein the guide member may include an opening through which at least a portion of the protrusion passes, and wherein the first sensing magnets may be disposed on the protrusion.

The camera module may further include a first driving unit configured to provide a driving force to the holder, wherein the first driving unit may include a first magnet disposed on a surface of the holder which faces the housing in a third axis direction, and a first coil disposed to face the first magnet.

The first magnet may include a combination of a pair of unipolar magnets which have different polarities.

The camera module may further include a second driving unit configured to provide a driving force to the guide member, wherein the second driving unit may include a second magnet disposed on a surface of the guide member which faces the housing in a second axis direction and a second coil disposed to face the second magnet.

The second magnet may include a combination of a pair of unipolar magnets which have different polarities.

The camera module may further include a plurality of ball members disposed between the guide member and the housing, wherein the plurality of ball members may include a center ball positioned on the first axis and a plurality of guide balls which support a rotation of the guide member.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of the example camera module illustrated in FIG. 1.

FIG. 3 illustrates a perspective view of the example camera module illustrated in FIG. 1, from which a case is removed.

FIG. 4 illustrates a perspective view of an example reflection module according to a first example embodiment.

FIG. 5 illustrates an exploded perspective view of the example reflection module illustrated in FIG. 4.

FIG. 6 illustrates a view of a bottom surface of the example reflection module illustrated in FIG. 5.

FIG. 7 illustrates a cutaway perspective view taken along line I-I′ of the example reflection module illustrated in FIG. 4.

FIG. 8 illustrates a cross-sectional view taken along line II-II′ of the example reflection module illustrated in FIG. 4.

FIG. 9 illustrates a front view of the example reflection module illustrated in FIG. 4.

FIG. 10 illustrates a view schematically of a driving of the reflection module according to a first example embodiment.

FIG. 11 illustrates a view of a comparative example of the example reflection module illustrated in FIG. 10.

FIG. 12 illustrates a graph of a change in magnetic field intensity sensed based on a rotation angle of the reflection module.

FIG. 13 illustrates a perspective view of an example reflection module according to a second example embodiment.

FIG. 14 illustrates a front view of the reflection module illustrated in FIG. 13.

FIG. 15 illustrates a perspective view of a state where a second lens module is separated from the example camera module, in accordance with one or more embodiments.

FIG. 16 illustrates a view of a bottom surface of the second lens module illustrated in FIG. 15.

FIG. 17 illustrates an exploded perspective view of an example camera module, in accordance with one or more embodiments.

FIG. 18 illustrates an exploded perspective view of the example camera module illustrated in FIG. 17, which is viewed from another angle.

FIG. 19 illustrates a perspective view of a housing illustrated in FIG. 17.

FIG. 20 illustrates a view of an X-Y cross section of the example camera module, in accordance with one or more embodiments.

FIG. 21 and FIG. 22 are views illustrating rotation driving of a holder included in an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Among the example embodiments disclosed in the specification, unless otherwise stated, a configuration included in an example embodiment may also be included in another example embodiment.

The one or more examples relate to a camera module, and the camera module may be mounted in a portable electronic device such as, but not limited to, a mobile communication terminal, a smartphone, or a tablet personal computer (PC).

One or more examples may provide a reflection module having improved sensitivity and linearity of position sensing for a rotating reflective member, and a camera module including the same.

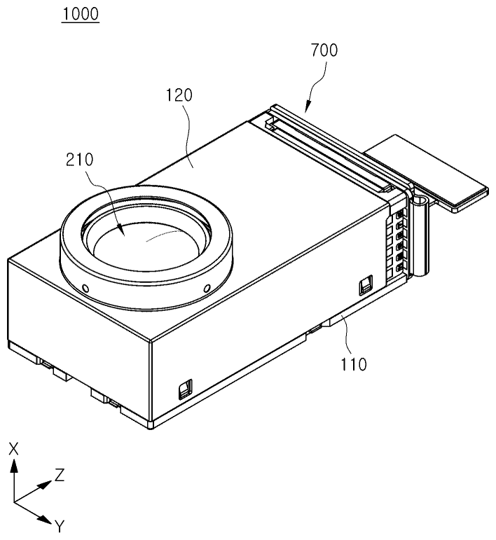

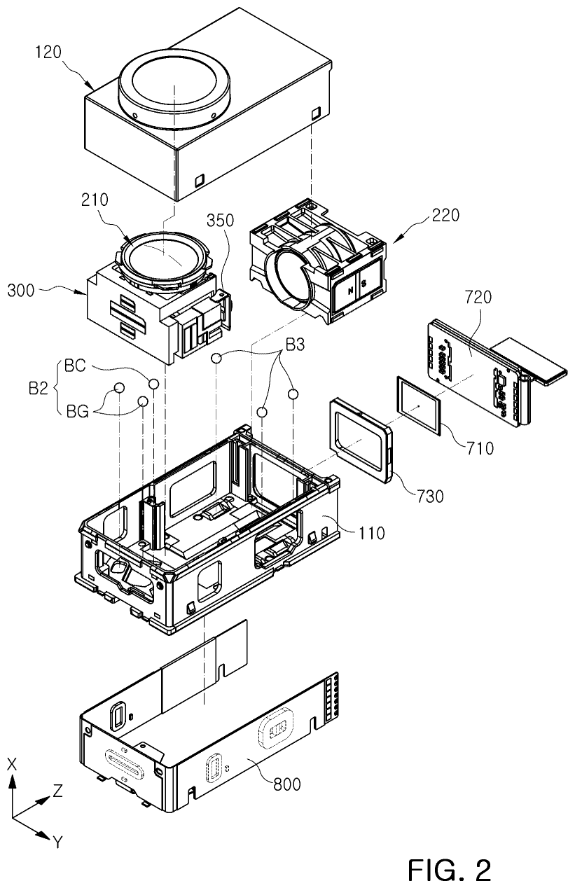

Referring to FIGS. 1 and 2, a reflection module 300 and a camera module 1000 including the same, according to an example embodiment, may include a driving unit and a position sensor for implementing an optical image stabilization (OIS) operation during the capturing of an image.

However, when the reflection module 300 performs tilt rotation, that is, rotation driving about a Y-axis in the drawings, if the camera module 1000 uses only one position sensor spaced apart from a first coil 420, a center of rotation may be misaligned, and an error may occur.

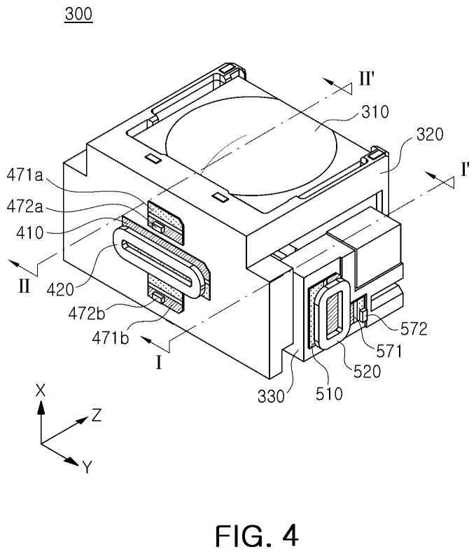

The reflection module 300 and the camera module 1000 including the same, according to an example embodiment, may symmetrically dispose one pair of position sensors 472a and 472b (FIG. 4) and sum sensing results, thereby enabling precise and high-linearity position sensing.

Hereinafter, detailed configurations of the reflection module 300 and the camera module 1000 including the same according to an example embodiment of the present disclosure is described in detail with reference to the drawings.

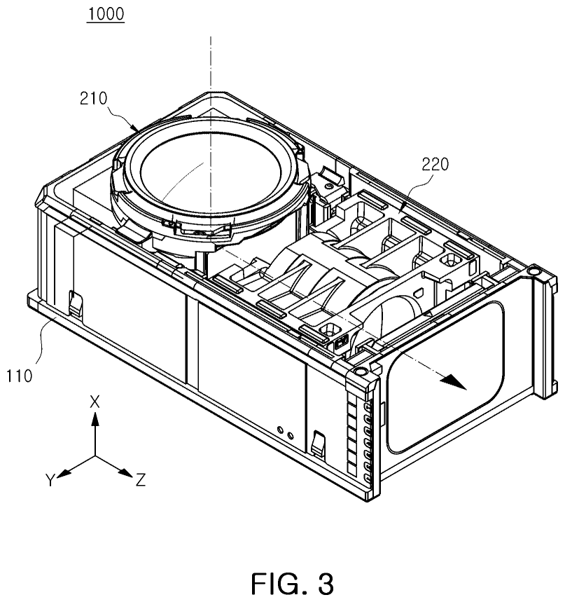

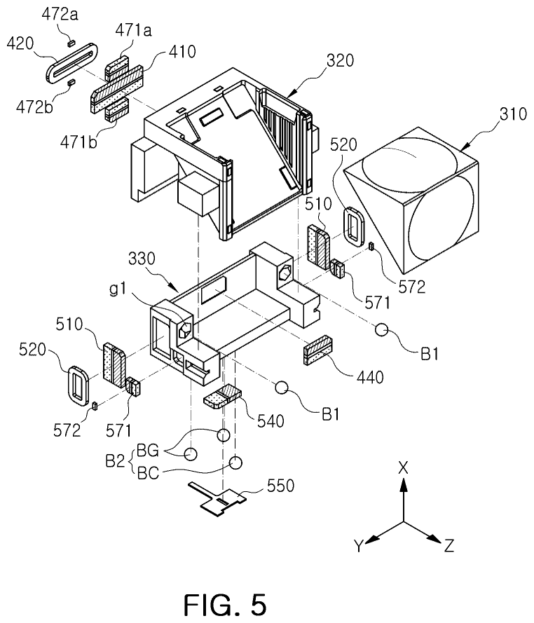

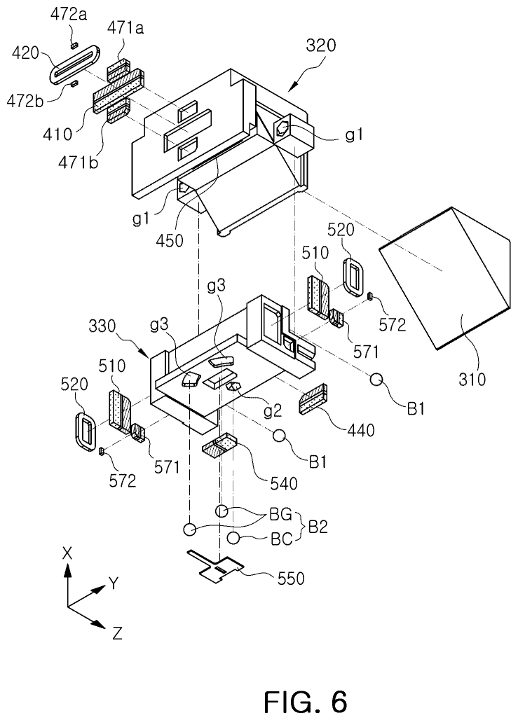

FIG. 1 is a perspective view of the camera module 1000 according to an example embodiment. FIG. 2 is an exploded perspective view of the camera module 1000 illustrated in FIG. 1. FIG. 3 is a perspective view of the camera module 1000 illustrated in FIG. 1, from which a case 120 is removed. FIG. 4 is a perspective view of the reflection module 300 according to a first example embodiment. FIG. 5 is an exploded perspective view of the reflection module 300 illustrated in FIG. 4. FIG. 6 is a view illustrating a bottom surface of the reflection module 300 illustrated in FIG. 5.

Referring to FIGS. 1 through 6, the camera module 1000 according to an example embodiment may include a first lens module 210, the reflection module 300, a second lens module 220, and a housing 110.

The first lens module 210 may include at least one lens and a first lens barrel. At least one lens may have a first optical axis (X-axis) and may be mounted in the first lens barrel. The first optical axis (X-axis) may extend in a vertical direction as illustrated in FIG. 1.

The first lens module 210 may be disposed in front of the reflection module 300. Here, “in front” may refer to a positive direction (+X-axis direction) of the first optical axis (X-axis) with respect to the reflection module 300. For example, the first lens module 210 may be disposed above the reflection module 300 in a first optical axis (X-axis) direction.

The first lens module 210 may be coupled to the reflection module 300. In an example, the first lens module 210 may be coupled to a holder 320 of the reflection module 300.

The reflection module 300 may include a reflective member 310, and the reflective member 310 may have a reflective surface that reflects light passing through the first lens module 210. As non-limited examples, the reflective member 310 may be implemented as a prism or a mirror. The reflective member 310 may be coupled to the holder 320.

The first lens module 210 and the reflection module 300 may be disposed in the housing 110.

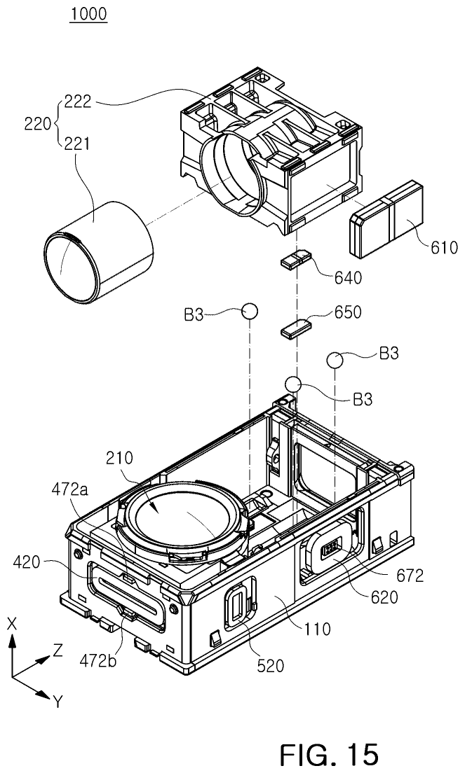

In an example embodiment, the camera module 1000 may further include the second lens module 220. The reflection module 300 may be disposed between the first lens module 210 and the second lens module 220. The second lens module 220 may include a plurality of lenses and a second lens barrel 221 (see FIG. 15). The plurality of lenses may have a second optical axis (Z-axis) and may be mounted in the second lens barrel 221. That is, the second lens module 220 may be disposed to allow light reflected from the reflective member 310 to pass through in a second optical axis (Z-axis) direction.

Referring to FIG. 3, the first optical axis (X-axis) of the first lens module 210 and the second optical axis (Z-axis) of the second lens module 220 may be perpendicular to each other.

The first lens module 210 may include at least one lens, and the second lens module 220 may include a plurality of lenses.

At least one lens of the first lens module 210 may be circular when viewed along the first optical axis (X-axis). Among the plurality of lenses of the second lens module 220, at least one lens may be non-circular when viewed along the second optical axis (Z-axis). In an example, a non-circular lens may have different lengths in two directions perpendicular to each other and perpendicular to the second optical axis (Z-axis). In an example embodiment, the non-circular lens may have a length in a first axis (Y-axis) direction, which is perpendicular to both the first optical axis (X-axis) and the second optical axis (Z-axis), and greater than in the first optical axis (X-axis) direction.

In an example, although the specification describes that the camera module 1000 includes the first lens module 210 and the second lens module 220, the camera module 1000 is not limited thereto, and, in an example, the camera module 1000 may include only one of the first lens module 210 and the second lens module 220.

In an example embodiment, the first lens module 210 and the reflective member 310 may rotate together for optical image stabilization. That is, the first lens module 210 and the reflective member 310 may rotate together about two axes perpendicular to each other.

In an example, the first lens module 210 and the reflective member 310 may rotate together about the first optical axis (X-axis), and may also rotate together about the first axis (Y-axis) perpendicular to both the first optical axis (X-axis) and the second optical axis (Z-axis).

In an example embodiment, the second lens module 220 may move along the second optical axis (Z-axis) direction to perform an optical zoom operation, an auto-focus (AF) operation, or the like.

The camera module 1000 in this example embodiment may further include an image sensor module 700.

The image sensor module 700 may include an image sensor 710, a sensor housing 730, and a sensor substrate 720, and may further include an infrared cut filter. The infrared cut filter may be mounted on the sensor housing 730. The infrared cut filter may block light in an infrared region.

The sensor substrate 720 may be coupled to the sensor housing 730, and the image sensor 710 may be disposed on a substrate 800.

Light passing through the second lens module 220 may be received by the image sensor 710 of the image sensor module 700.

The camera module 1000 in this example embodiment may further include the case 120. The case 120 may be coupled to the housing 110 to cover an upper portion of the housing 110. The case 120 may have an opening, and the first lens module 210 may be disposed in the opening.

In an example, at least a portion of the first lens module 210 may protrude outward from the housing 110.

Referring to FIGS. 4 through 6, the reflection module 300 may include the reflective member 310, the holder 320, and a guide member 330.

The reflective member 310 may include a reflective surface for reflecting light passing through the first lens module 210. As non-limiting examples, the reflective member 310 may be implemented as a prism or a mirror.

When the reflective member 310 is implemented as a prism, the reflective member 310 may have a shape obtained by bisecting a rectangular or cubic block in a diagonal direction. The prism may include an incident surface through which light is incident, a reflective surface for reflecting light passing through the incident surface, and an emission surface through which light reflected from the reflective surface is emitted.

The reflective member 310 may be mounted on the holder 320. The first lens module 210 may be disposed in front of the reflective member 310. In an example embodiment, the first lens module 210 may be mounted on the holder 320.

The holder 320 may be rotatably disposed in the guide member 330. Additionally, the guide member 330 may be rotatably disposed in the housing 110.

The guide member 330 may be rotatable about the first optical axis (X-axis). For example, the guide member 330 may be rotatable relative to the housing 110 about the first optical axis (X-axis). In this example, the first lens module 210 and the holder 320 may also rotate together with the guide member 330. In an example, in the specification, the first optical axis (X-axis) may also be referred to as a first rotation axis (RA1).

The holder 320 may be rotatable about the first axis (Y-axis) perpendicular to both the first optical axis (X-axis) and the second optical axis (Z-axis). For example, the holder 320 may be rotatable relative to the guide member 330 about the first axis (Y-axis). In an example, the first lens module 210 may rotate together with the holder 320. In an example, in the specification, the first axis (Y-axis) may also be referred to as a second rotation axis (RA2).

The camera module 1000 in this example embodiment may include a first driving unit 400 to control a rotation of the holder 320. The first driving unit 400 may include a first magnet 410 and the first coil 420. By the first driving unit 400, the holder 320 may be rotated about the first axis (Y-axis). The first lens module 210 may be disposed on the holder 320, and the first lens module 210 may thus also rotate together with the holder 320.

The first magnet 410 may be mounted on the holder 320. In an example embodiment, the first magnet 410 may be mounted on one surface of the holder 320.

The first magnet 410 may be magnetized to have one surface (e.g., a surface facing the first coil 420) having both a north pole (N pole) and a south pole (S pole). In an example embodiment, the surface of the first magnet 410 facing the first coil 420 may be magnetized to have the N pole, a neutral region, and the S pole sequentially along the first optical axis (X-axis) direction.

In an example, the first magnet 410 may have a shape extending along the first axis (Y-axis) direction. For example, the first magnet 410 may have a length in the first axis (Y-axis) direction that is greater than a length in the first optical axis (X-axis) direction.

The first coil 420 may face the first magnet 410. In an example embodiment, the first coil 420 may be disposed to face the first magnet 410 in the second optical axis (Z-axis) direction.

In an example, the first coil 420 may have a shape extending along the first axis (Y-axis) direction. For example, the first coil 420 may have a length in the first axis (Y-axis) direction that is greater than a length in the first optical axis (X-axis) direction.

The first coil 420 may be disposed on the substrate 800, and the substrate 800 may be mounted in the housing 110 to have the first magnet 410 and the first coil 420 facing each other in the second optical axis (Z-axis) direction.

A through-hole passing through the housing 110 in the second optical axis (Z-axis) direction may be formed in the housing 110, and the first coil 420 may be disposed in the through-hole to directly face the first magnet 410.

When the optical image stabilization (OIS) operation is implemented, the first magnet 410 may correspond to a moving member mounted on the holder 320 to rotate together with the holder 320, and the first coil 420 may correspond to a fixed member that is fixed to the substrate 800.

When power is applied to the first driving unit 400, the first driving unit 400 may generate a driving force necessary for the rotation of the holder 320 about the first axis (Y-axis). The first driving unit 400 may generate the driving force in the first optical axis (X-axis) direction.

Referring to FIGS. 5 and 6, a first ball member B1 may be disposed between the holder 320 and the guide member 330. The first ball member B1 may be disposed between the holder 320 and the guide member 330 to form a rotation axis of the holder 320.

The first ball member B1 may include a plurality of balls that are spaced apart from each other in the first axis (Y-axis) direction.

When viewed in the first axis (Y-axis) direction, a portion of the reflective surface of the reflective member 310 may overlap with the first ball member B1.

An imaginary line connecting the plurality of balls of the first ball member B1 to each other in the first axis (Y-axis) direction may pass through the reflective surface of the reflective member 310.

Referring to FIG. 6, an attractive force may act between the holder 320 and the guide member 330. In an example embodiment, a first pulling magnet 440 may be disposed on one of the holder 320 and the guide member 330, and a first pulling yoke 450 may be disposed on the other of the holder 320 and the guide member 330. However, the configuration is not limited thereto, and the first pulling magnet 440 may be disposed on both the holder 320 and the guide member 330.

One surface (e.g., a surface facing the first pulling yoke 450) of the first pulling magnet 440 may be magnetized to have the N pole, the neutral region, and the S pole disposed in the first optical axis (X-axis) direction.

The first pulling magnet 440 and the first pulling yoke 450 may face each other in the second optical axis (Z-axis) direction.

The first pulling magnet 440 and the first pulling yoke 450 may generate an attractive force between each other. For example, the first pulling yoke 450 may be made of a magnetic material. The attractive force may act between the first pulling magnet 440 and the first pulling yoke 450 in the second optical axis (Z-axis) direction.

By the attractive force acting between the first pulling magnet 440 and the first pulling yoke 450, the first ball member B1 may maintain contact with each of the holder 320 and the guide member 330.

First guide grooves g1 may be disposed on surfaces of the holder 320 and the guide member 330 facing each other (e.g., surfaces facing each other in the second optical axis (Z-axis) direction), respectively.

The first ball member B1 may be disposed between the first guide groove g1 of the holder 320 and the first guide groove g1 of the guide member 330 to form the rotation axis of the holder 320.

The camera module 1000 in this example embodiment may include a second driving unit 500 to control a rotation of the reflection module 300. The second driving unit 500 may include a second magnet 510 and a second coil 520. By the second driving unit 500, the guide member 330 may rotate about the first optical axis (X-axis) with respect to the housing 110. The holder 320 and the first lens module 210 may be disposed in the guide member 330, and the holder 320 and the first lens module 210 may thus also rotate together with the guide member 330.

The second magnet 510 may be mounted on the guide member 330. For example, the second magnet 510 may be disposed on a side surface of the guide member 330 to face the second coil 520. The side surface of the guide member 330 may refer to its surface facing the housing 110 in the first axis (Y-axis) direction. For example, the side surface of the guide member 330 may refer to an outer surface of the guide member 330 perpendicular to the first axis (Y-axis).

The second magnet 510 may include two magnets respectively disposed on both side surfaces of the guide member 330. The two magnets may be spaced apart from each other in the first axis (Y-axis) direction.

Each of the two magnets included in the second magnet 510 may be magnetized to have one surface (e.g., a surface facing the second coil 520) having both N pole and S pole. In an example embodiment, one surface of the second magnet 510 facing the second coil 520 may be magnetized to have the N pole, the neutral region, and the S pole disposed sequentially along the second optical axis (Z-axis) direction.

The second magnet 510 may have a shape extending in the first optical axis (X-axis) direction. For example, the second magnet 510 may have a length in the first optical axis (X-axis) direction that is greater than a length in the second optical axis (Z-axis) direction.

The second coil 520 may face the second magnet 510. In an example embodiment, the second coil 520 may be disposed to face the second magnet 510 in the first axis (Y-axis) direction.

The second coil 520 may have a shape extending in the first optical axis (X-axis) direction. For example, the second coil 520 may have a length in the first optical axis (X-axis) direction that is greater than a length in the second optical axis (Z-axis) direction.

The second coil 520 may be disposed on the substrate 800, and the substrate 800 may be mounted in the housing 110 to have the second magnet 510 and the second coil 520 facing each other in the first axis (Y-axis) direction.

A through-hole passing through the housing 110 in the first axis (Y-axis) direction may be formed in the housing 110, and the second coil 520 may be disposed in the through-hole to directly face the second magnet 510.

The second coil 520 may include two coils. The two coils may be spaced apart from each other in the first axis (Y-axis) direction.

When the optical image stabilization (OIS) operation is implemented, the second magnet 510 may correspond to a moving member mounted on the guide member 330 to rotate together with the guide member 330, and the second coil 520 may correspond to a fixed member fixed to the substrate 800.

When power is applied to the second driving unit 500, the second driving unit 500 may generate a driving force necessary for rotation of the guide member 330 about the first optical axis (X-axis).

Referring to FIGS. 5 and 6, a second ball member B2 may be disposed between the guide member 330 and the housing 110.

The second ball member B2 may include a center ball BC, which forms a rotation axis of the guide member 330, and a plurality of guide balls BG which support a rotation of the guide member 330. The guide member 330 may be supported at three points by the center ball BC and the plurality of guide balls BG.

An imaginary line extending in the first optical axis (X-axis) of the first lens module 210 may pass through the center ball BC.

An attractive force may act between the guide member 330 and the housing 110. In an example embodiment, a second pulling magnet 540 may be disposed on a lower surface (e.g., a surface facing the housing 110) of the guide member 330. Additionally, a second pulling yoke 550 may be disposed to face the second pulling magnet 540 in the first optical axis (X-axis) direction. In an example embodiment, the second pulling yoke 550 may be disposed in the housing 110.

The second pulling magnet 540 and the second pulling yoke 550 may generate an attractive force between each other. In an example, the second pulling yoke 550 may be made of a magnetic material. The attractive force may act between the second pulling magnet 540 and the second pulling yoke 550 in the first optical axis (X-axis) direction.

By the attractive force acting between the second pulling magnet 540 and the second pulling yoke 550, the second ball member B2 may maintain contact with each of the guide member 330 and the housing 110.

A second guide groove g2 and a third guide groove g3 may be disposed on surfaces of the guide member 330 and the housing 110 facing each other (e.g., surfaces facing each other in the first optical axis (X-axis) direction), respectively. The center ball BC may be disposed in the second guide groove g2, and the plurality of guide balls BG may be disposed in the third guide groove g3.

In an example embodiment, the center ball BC may be in three-point contact with the second guide groove g2 of the guide member 330, and may be in three-point contact with the second guide groove g2 of the housing 110. The center ball BC may be disposed between the second guide groove g2 of the guide member 330 and the second guide groove g2 of the housing 110 to form the first rotation axis (RA1) of the guide member 330.

In an example embodiment, each of the plurality of guide balls BG may be in one-point contact with the third guide groove g3 of the guide member 330 and in one-point contact with the third guide groove g3 of the housing 110.

In another example embodiment, each of the plurality of guide balls BG may be in two-point contact with the third guide groove g3 of the guide member 330 and in one-point contact with the third guide groove g3 of the housing 110. However, the configuration is not limited thereto, and in an example, each of the plurality of guide balls BG may be in one-point contact with the third guide groove g3 of the guide member 330 and in two-point contact with the third guide groove g3 of the housing 110.

In an example, referring to FIG. 2, the reflection module 300 may further include a stopper 350. The stopper 350 may be coupled to the guide member 330 to cover at least a portion of the holder 320. For example, the stopper 350 may cover at least a portion of an upper surface of the holder 320. The stopper 350 and the holder 320 may be spaced apart from each other in the first optical axis (X-axis) direction.

The stopper 350 may be disposed to be spaced apart from the holder 320, and the stopper 350 may thus prevent the holder 320 from being separated from the guide member 330 due to an external impact or the like while not interfering with the rotation of the holder 320.

A buffer member having elasticity may be coupled to the stopper 350. The buffer member may be disposed on at least one surface of the stopper 350 facing the holder 320.

Hereinafter, configurations for sensing a position of the reflection module 300 in this example embodiment is described in detail with reference to the drawings.

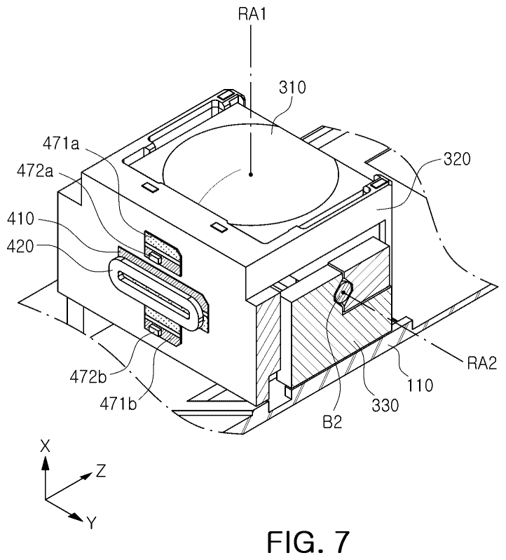

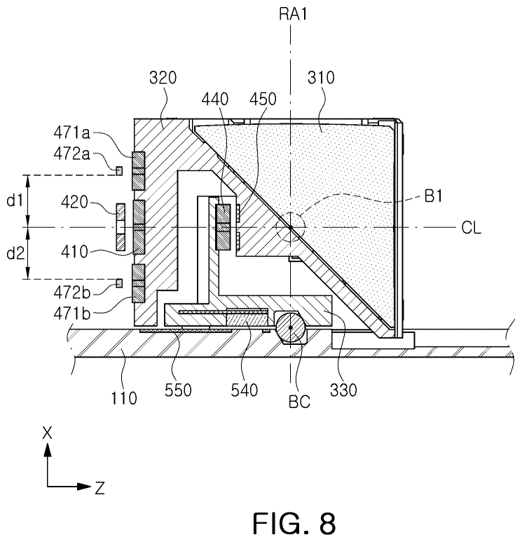

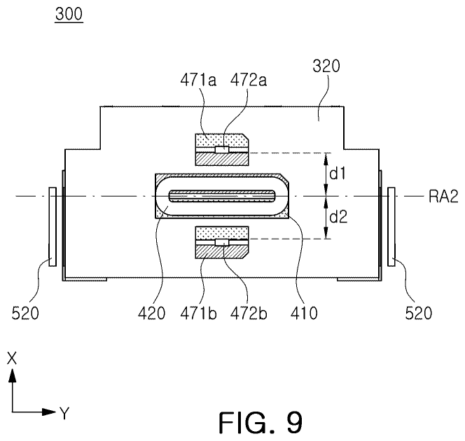

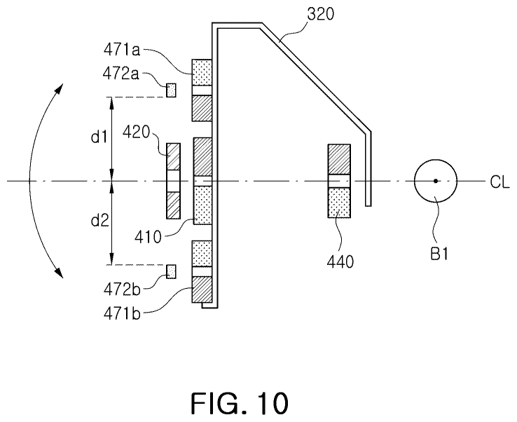

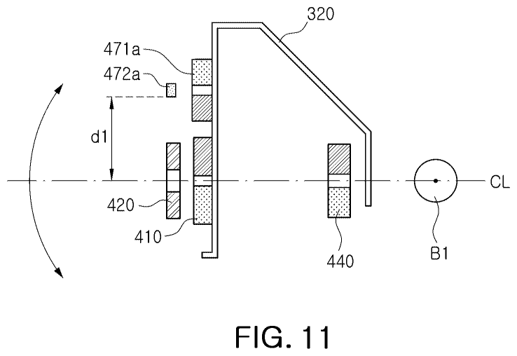

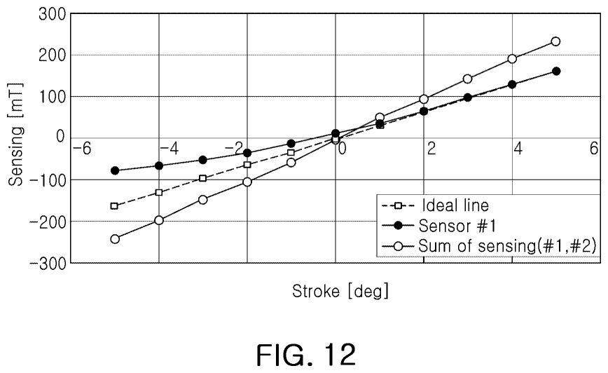

FIG. 7 is a cutaway perspective view taken along line I-I′ of the reflection module 300 illustrated in FIG. 4. FIG. 8 is a cross-sectional view taken along line II-II′ of the reflection module 300 illustrated in FIG. 4. FIG. 9 is a front view of the reflection module 300 illustrated in FIG. 4. FIG. 10 is a view schematically illustrating driving of the reflection module 300 according to a first example embodiment. FIG. 11 is a view illustrating a comparative example of the reflection module 300 illustrated in FIG. 10. FIG. 12 is a graph illustrating a change in magnetic field intensity sensed based on a rotation angle of the reflection module 300.

Referring to FIGS. 7 through 10, the camera module 1000, according to an example embodiment, may include a first position sensing unit 470 that detects a position of the holder 320. The first position sensing unit 470 may include a first sensing magnet 471 and a first position sensor 472. Additionally, the first position sensing unit 470 may further include a controller that performs summation or the like of sensing results therefrom, and is not limited thereto.

When the holder 320 rotates about the first axis (Y-axis), that is, the second rotation axis (RA2), the first position sensing unit 470 may detect the position of the holder 320.

The first sensing magnet 471 may be disposed on one surface of the holder 320. Additionally, the first sensing magnet 471 may be disposed to be spaced apart from the first magnet 410. For example, the first sensing magnet 471 may be disposed to be spaced apart from the first magnet 410 in the first optical axis (X-axis) direction.

In an example, the camera module 1000 in this example embodiment may include at least one pair of first sensing magnets 471a and 471b. The pair of first sensing magnets 471a and 471b may be disposed on one surface of the holder 320, and may be spaced apart from each other in a direction parallel to the first optical axis (X-axis), that is, the first rotation axis (RA1). Each of the pair of first sensing magnets 471a and 471b may be disposed symmetrically with respect to the first magnet 410.

Each of the first magnet 410 and the first sensing magnet 471 in this example embodiment may have two polarities disposed in the direction parallel to the first rotation axis (RA1). Additionally, a region where the first magnet 410 and the first sensing magnet 471 face each other may have the same polarity. That is, referring to FIG. 7, when the first magnet 410 has the N pole and the S pole disposed sequentially along the vertical direction, the first sensing magnet 471a disposed above the first magnet 410 may have the S pole and the N pole disposed sequentially along the vertical direction. Additionally, the first sensing magnet 471b disposed below the first magnet 410 may have the S pole and the N pole disposed sequentially along the vertical direction.

When a polarity relationship between the first magnet 410 and the first sensing magnet 471 is disposed as described above, a sensing error caused by Hall coupling may be reduced.

In an example, the first magnet 410 may have a structure in which a plurality of unipolar magnets are combined with each other. For example, the first magnet 410 may have a combined structure in which a magnet having the N pole and a magnet having the S pole are sequentially disposed along the vertical direction. In this manner, when the first magnet 410 includes a combination of the plurality of unipolar magnets, the neutral region between the N pole and the S pole may be minimized, thereby improving driving force and driving accuracy.

Additionally, the first sensing magnet 471 may have a structure in which a plurality of unipolar magnets are combined with each other. For example, the first sensing magnet 471 may have a combined structure in which a magnet having the S pole and a magnet having the N pole are sequentially disposed along the vertical direction. In this manner, when the first sensing magnet 471 includes a combination of the plurality of unipolar magnets, a neutral region between the N pole and the S pole may be minimized, thus improving sensing accuracy.

The camera module 1000 according to an example embodiment may include a separate first sensing magnet 471 to sense the position of the holder 320, and a size of the first coil 420 facing the first magnet 410 may thus be sufficiently increased. Accordingly, a magnitude of the driving force of the first driving unit 400 may be increased.

The first position sensor 472 may be disposed at a position that allows detection of a positional change of the first sensing magnet 471. In an example, the first position sensor 472 may be a Hall sensor.

The first position sensor 472 in this example embodiment may include at least one pair of position sensors, and the pair of first position sensors 472a and 472b may be disposed on one surface of the housing 110. For example, the first position sensors 472a and 472b may be disposed on one surface of the housing 110 facing the holder 320. Accordingly, at least one pair of first position sensors 472 may be disposed to face at least one pair of first sensing magnets 471, respectively.

Additionally, at least one pair of first position sensors 472a and 472b may be disposed symmetrically with respect to the center of the first coil 420, respectively.

In detail, each of the first position sensors 472a and 472b may be disposed in the direction parallel to the first optical axis (X-axis), that is, the first rotation axis (RA1). In addition, each of the first position sensors 472a and 472b may be disposed to be spaced apart from the center of the first coil 420 in the direction parallel to the first optical axis (X-axis), that is, the first rotation axis (RA1).

Referring to FIG. 8, each of the pair of first position sensors 472a and 472b may be disposed symmetrically with respect to an imaginary center line (CL) extending along the second optical axis (Z-axis). Additionally, each of the pair of first position sensors 472a and 472b may be disposed to be spaced apart from the imaginary center line (CL) in the direction parallel to the first rotation axis (RA1) (i.e., X-axis direction). Additionally, the respective shortest distances d1 and d2 between the first position sensors 472a and 472b and the center line (CL) may be equal to each other. Here, “equal” may be defined to include not only exactly identical but also a concept including substantially identical values. “Substantially identical” refers to a state that includes manufacturing tolerance, positional deviation, or measurement error occurring during the process.

In an example, when an imaginary plane perpendicular to the first rotation axis (RA1) and including the second rotation axis (RA2) is set, the number of first position sensors (e.g., 472a) facing one side of the plane may be equal to the number of first position sensors (e.g., 472b) facing the other side of the plane among at least one pair of first position sensors. That is, although this example embodiment assumes the example in which two first position sensors 472a and 472b are disposed, additional first position sensors may also be disposed. Even in such an example, additional first position sensors may be provided in pairs, the same number of sensors may be disposed in upper and lower regions, and the sensors may be symmetrically positioned.

Referring to FIGS. 8 through 10, based on the imaginary plane, the distance d1 between the first position sensor 472a facing one side of the plane and the plane may be equal to the distance d2 between the first position sensor 472b facing the other side of the plane and the plane. Here, “equal” may be defined to include not only exactly identical but also a concept including substantially identical cases. “Substantially identical” refers to a state that includes manufacturing tolerance, positional deviation, or measurement error occurring during the process.

When power is applied to the first coil 420, Hall coupling caused by a magnetic field of the first coil 420 may occur, and an error may thus occur at the position of the holder 320 detected by the first position sensor 472. However, the camera module 1000 according to an example embodiment of the present disclosure may include the first position sensor 472 disposed to be spaced apart from the first coil 420, thereby improving accuracy in sensing the position of the holder 320.

In particular, the camera module 1000 in this example embodiment may include one pair of first position sensors 472a and 472b disposed to be spaced apart from each other in parallel with the direction of the first rotation axis (RA1). Such a structure may enable correction for misaligned position sensing with respect to the second rotation axis (RA2), thereby improving accuracy and linearity of the position sensing.

In an example, the first position sensing unit 470 in this example embodiment may include the first sensing magnet 471 and the first position sensor 472, and may further include the controller that may calculate a result sensed from these components. For example, the first position sensing unit 470 may sum the results sensed from the respective first position sensors 472a and 472b by using the controller. As a result, accurate sensing of the position of the holder 320 may be achieved, and sensing linearity may be improved.

Referring to FIGS. 4 through 6, the camera module 1000 according to an example embodiment may include a second position sensing unit 570 that detects a position of the guide member 330. The second position sensing unit 570 may include a second sensing magnet 571 and a second position sensor 572.

When the guide member 330 rotates about the first optical axis (X-axis) as a rotation axis, the position of the guide member 330 may be detected using the second position sensing unit 570.

The second sensing magnet 571 may be disposed on one surface (e.g., a side surface) of the guide member 330. Additionally, the second sensing magnet 571 may be disposed to be spaced apart from the second magnet 510.

The second sensing magnet 571 may be magnetized to have one surface having both the N pole and the S pole. In an example embodiment, one surface of the second sensing magnet 571 may have the N pole, the neutral region, and the S pole disposed sequentially along the second optical axis (Z-axis) direction.

The camera module 1000 according to an example embodiment may include a separate second sensing magnet 571 that senses the position of the guide member 330, thereby sufficiently increasing a size of the second coil 520 facing the second magnet 510. Accordingly, a magnitude of a driving force of the second driving unit 500 may be increased.

The second position sensor 572 may be disposed at a position that allows it to detect a positional change of the second sensing magnet 571. In an example embodiment, the second sensing magnet 571 and the second position sensor 572 may be disposed to face each other in the first axis (Y-axis) direction.

The second position sensor 572 may be disposed to be spaced apart from the second coil 520. The second position sensor 572 may be a Hall sensor.

When power is applied to the second coil 520, Hall coupling caused by a magnetic field of the second coil 520 may occur, and an error may thus occur at the position of the guide member 330 detected by the second position sensor 572. However, the camera module 1000 according to an example embodiment may include the second position sensor 572 disposed to be spaced apart from the second coil 520, thereby improving accuracy in sensing the position of the guide member 330.

In an example, a through-hole passing through the housing 110 in the first axis (Y-axis) direction may be formed in the housing 110, and the substrate 800 covering the through-hole may be disposed on the side surface of the housing 110. Additionally, the second position sensor 572 may be disposed on the substrate 800.

Hereinafter, an effect according to the arrangement of the first position sensor 472 as in this example embodiment is described with reference to FIGS. 10 through 12.

FIG. 10 is a view schematically illustrating driving of the reflection module 300 according to a first example embodiment. FIG. 11 is a view illustrating a comparative example of the reflection module 300 illustrated in FIG. 10. FIG. 12 is a graph illustrating a change in the magnetic field intensity sensed based on the rotation angle of the reflection module 300.

Referring to FIGS. 10 and 11, to implement the optical image stabilization (OIS) operation, tilt rotation of the holder 320 may be performed about a rotation axis formed by the first ball member 1. In an example, considering a driving range of the tilt rotation, it may be beneficial to position the first magnet 410 and the first coil 420 on the center line (CL) of the rotation axis. Accordingly, the first position sensor 472 may be disposed to be spaced apart from the center line (CL) to face the first sensing magnet 471.

In this example, as illustrated in FIG. 11, when only one first position sensor 472a is disposed, a sensing error may occur due to a misalignment from the center line (CL). That is, depending on an angle at which the holder 320 performs the tilt rotation, a non-linear region may occur in magnetic field intensity measured by the first position sensor 472a.

In comparison, as in the camera module 1000 according to an example embodiment, when one pair of first position sensors 472a and 472b are disposed symmetrically with respect to the center line (CL), linearity may be ensured by summing the sensing results from the two first position sensors 472a and 472b.

TABLE 1

Magnetic field intensity [mT]

| Rotation | | Summation of sensing |
|---|---|---|
| angle | Sensing by a | results from two |
| [deg] | single first sensor | first sensors |
| −5 | −78.9 | −243.4 |
| −4 | −67.4 | −200.0 |
| −3 | −53.2 | −151.1 |
| −2 | −35.5 | −106.6 |
| −1 | −15.1 | −60.2 |
| 0 | 8.7 | −3.3 |
| 1 | 35.3 | 46.9 |
| 2 | 64.5 | 93.0 |
| 3 | 95.5 | 141.8 |
| 4 | 127.5 | 190.7 |
| 5 | 159.8 | 231.7 |

TABLE 2

| | Sensing by a | Summation of sensing |
|---|---|---|
| | single first | results from two |
| | sensor | first sensors |
| Sensing sensitivity | 24.78 | 48.83 |
| [mT/deg] | | |
| linearity [deg] | 0.50 | 0.02 |

Table 1 illustrates magnetic field intensities measured based on rotation angles in the examples illustrated in FIGS. 10 and 11. Table 2 illustrates sensing sensitivities and linearities in the respective examples based on the results of Table 1. The linearity in Table 2 represents a difference from an ideal graph, and it may be interpreted that the closer the value is to zero, the higher the linearity.

Referring to FIG. 12 and Tables 1 and 2 above, in the example in which position sensing is performed using a single first position sensor 472a, as illustrated in FIG. 11, it is confirmed that an error with respect to an ideal line (indicated by a dotted line) increases as a stroke angle in a negative direction increases.

In comparison, as illustrated in FIG. 10, when one pair of first position sensors 472a and 472b are disposed and the sensing results therefrom are summed, it is confirmed that sensing sensitivity and linearity are significantly improved.

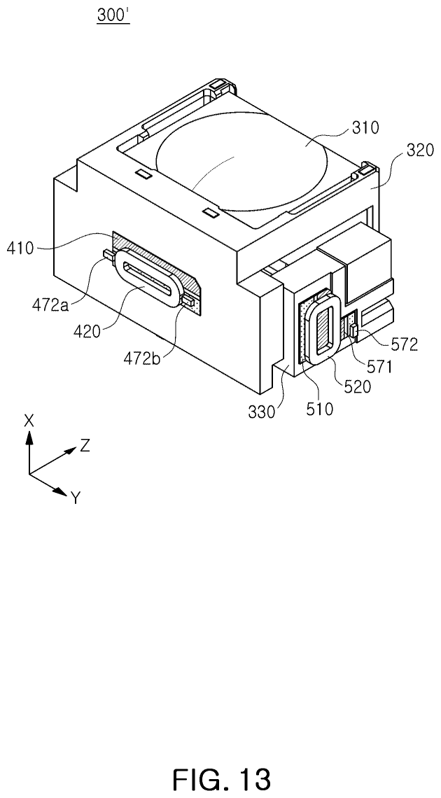

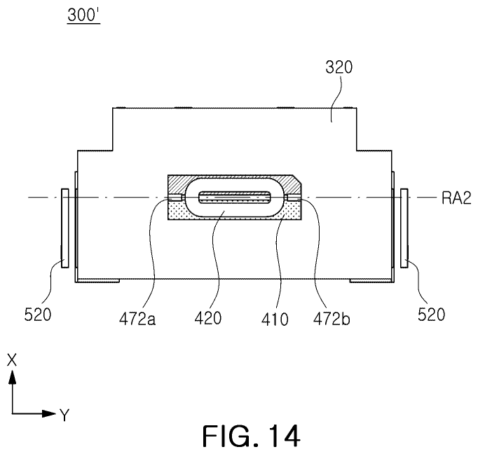

FIG. 13 is a perspective view of a reflection module 300′ according to another example embodiment. FIG. 14 is a front view of the reflection module 300′ illustrated in FIG. 13.

When FIG. 13 is compared with FIG. 4, the reflection module 300′ in this example embodiment does not include the first sensing magnet 471, and the first position sensors 472a and 472b may be differently positioned. Accordingly, in describing this example embodiment, the description only focuses on differences regarding the inclusion of the first sensing magnet 471 and the arrangement of the first position sensors 472a and 472b, which are different from those in the first example embodiment, and other configurations may be applied in the same manner as described in the first example embodiment.

Referring to FIGS. 13 and 14, the first position sensing unit 470 of the reflection module 300′ in this example embodiment may include only the first position sensors 472a and 472b, and may not include a separate first sensing magnet. A portion of the first magnet 410 in this example embodiment may be used to generate a driving force, and another portion of the first magnet 410 may be used for position sensing.

In an example, at least one pair of first position sensors 472a and 472b in this example embodiment may be disposed in a direction parallel to the second rotation axis (RA2).

Additionally, when taking an imaginary plane that is perpendicular to the first rotation axis (RA1) as an example, that is, the first optical axis (X-axis), and includes the second rotation axis (RA2), that is, the first axis (Y-axis), the plane may pass through at least one pair of the first position sensors 472a and 472b.

In other words, in this example embodiment, when one pair of first position sensors 472a and 472b are projected in the second optical axis (Z-axis) direction, the sensors 472a and 472b may be disposed on the second rotation axis (RA2). Accordingly, sensing errors of the first position sensors 472a and 472b caused by the rotation of the holder 320 may be minimized.

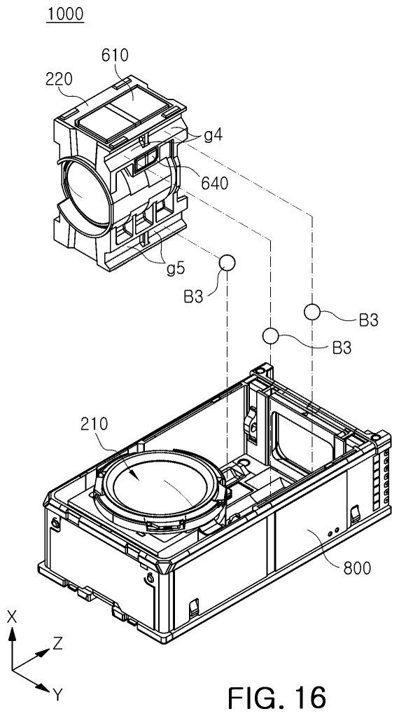

FIG. 15 is a perspective view illustrating an example where the second lens module 220 is separated from the camera module 1000 according to an example embodiment. FIG. 16 is a view illustrating a bottom surface of the second lens module 220 illustrated in FIG. 15.

Referring to FIGS. 15 and 16, the second lens module 220 may be disposed between the reflection module 300 and the image sensor module 700.

The second lens module 220 may move in the second optical axis (Z-axis) direction to perform focus adjustment.

In an example embodiment, the second lens module 220 may include the second lens barrel 221 and a carrier 222. The plurality of lenses may be disposed in the second lens barrel 221, and the second lens barrel 221 may be coupled to the carrier 222.

The camera module 1000 may include a third driving unit 600 which moves the second lens module 220 in the second optical axis (Z-axis) direction.

The third driving unit 600 may include a third magnet 610 and a third coil 620. The third magnet 610 and the third coil 620 may be disposed to face each other in the first axis (Y-axis) direction.

The third magnet 610 may be mounted on the second lens module 220. The third magnet 610 may be disposed on one side surface of the second lens module 220 (e.g., one side surface of the carrier 222).

In an example embodiment, the second lens module 220 may include a first side surface and a second side surface spaced apart from each other in the first axis (Y-axis) direction. Additionally, the third magnet 610 may be disposed on one side surface of the second lens module 220.

The third magnet 610 may be magnetized to have one surface (e.g., a surface facing the third coil 620) having both the N pole and the S pole. For example, one surface of the third magnet 610 facing the third coil 620 may have the N pole, the neutral region, and the S pole disposed sequentially along the second optical axis (Z-axis) direction.

The third coil 620 may face the third magnet 610. For example, the third coil 620 may be disposed to face the third magnet 610 in the first axis (Y-axis) direction.

The third coil 620 may be disposed on the substrate 800, and the substrate 800 may be mounted on the housing 110 to have the third magnet 610 and the third coil 620 facing each other in the first axis (Y-axis) direction.

A through-hole passing through the housing 110 may be formed in the housing 110, and the third coil 620 disposed on the substrate 800 may directly face the third magnet 610 through the through-hole.

During driving of the optical zoom operation or the auto-focus (AF) operation, the third magnet 610 may correspond to a moving member mounted on the second lens module 220 to move together with the second lens module 220 in the second optical axis (Z-axis) direction, and the third coil 620 may correspond to a fixed member fixed to the substrate 800.

When power is applied to the third coil 620, the second lens module 220 may move in the second optical axis (Z-axis) direction by an electromagnetic force generated between the third magnet 610 and the third coil 620.

A third ball member B3 may be disposed between the second lens module 220 and the housing 110, and the second lens module 220 may be guided by the third ball member B3 to move in the second optical axis (Z-axis) direction. The third ball member B3 may include a plurality of balls.

A third pulling magnet 640 may be disposed on a lower surface of the second lens module 220, and a third pulling yoke 650 may be disposed on an inner bottom surface of the housing 110. However, the configuration is not limited thereto, and third pulling magnets 640 may also be disposed on both of the second lens module 220 and the housing 110.

The third pulling magnet 640 may be disposed to be closer to one side surface of the second lens module 220. That is, the third pulling magnet 640 may be disposed to be closer to a first side surface of the second lens module 220 than to a second side surface thereof. Additionally, the third pulling magnet 640 may be disposed between one side surface of the second lens module 220 and the second optical axis (Z-axis).

The third pulling magnet 640 and the third pulling yoke 650 may be disposed to face each other in the first optical axis (X-axis) direction.

The third pulling magnet 640 and the third pulling yoke 650 may generate an attractive force between each other. In an example, the attractive force may act between the third pulling magnet 640 and the third pulling yoke 650 in the first optical axis (X-axis) direction.

By the attractive force acting between the third pulling magnet 640 and the third pulling yoke 650, the third ball member B3 may be in contact with each of the second lens module 220 and the housing 110.

Among the plurality of balls included in the third ball member B3, some of the plurality of balls may be disposed to be closer to a first side surface of the second lens module 220 than to a second side surface, and the remaining of the plurality of balls may be disposed to be closer to the second side surface than to first side surface thereof.

The number of balls disposed between a first side surface of the second lens module 220 and the second optical axis (Z-axis) may be greater than the number of balls disposed between a second side surface of the second lens module 220 and the second optical axis (Z-axis).

In a non-limited example embodiment, the third ball member B3 may include three balls. Two of the three balls may be disposed between a first side surface of the second lens module 220 and the second optical axis (Z-axis), and the remaining one ball may be disposed between the second side surface of the second lens module 220 and the second optical axis (Z-axis).

The two balls disposed between the first side surface of the second lens module 220 and the second optical axis (Z-axis) may be spaced apart from each other in the second optical axis (Z-axis) direction.

Surfaces of the second lens module 220 and the housing 110 facing each other may have fourth and fifth guide grooves g4 and g5, respectively. For example, the fourth guide groove g4 may be disposed on a first side of each of the surfaces of the second lens module 220 and the housing 110 facing each other, and the fifth guide groove g5 may be disposed on a second side of the surfaces.

The fourth guide groove g4 and the fifth guide groove g5 may be spaced apart from each other in the first axis (Y-axis) direction. The fourth guide groove g4 and the fifth guide groove g5 may extend along the direction parallel to the second optical axis (Z-axis).

Among the plurality of balls included in the third ball member B3, some of the plurality of balls may be disposed in the fourth guide groove g4, and the remaining of the plurality of balls may be disposed in the fifth guide groove g5.

The number of contact points between some of the plurality of balls and the fourth guide groove g4 may be greater than the number of contact points between the remaining balls and the fifth guide groove g5.

The fourth guide groove g4 may be disposed to be closer to one side surface of the second lens module 220 than to the fifth guide groove g5.

The third pulling magnet 640 may be disposed to be closer to the fourth guide groove g4 than to the fifth guide groove g5.

In an example embodiment, the camera module 1000 may detect a position of the second lens module 220. Accordingly, a third position sensor 672 may be disposed. The third position sensor 672 may be disposed to face the third magnet 610 of the third driving unit 600 (e.g., to face the third magnet 610 in the first axis (Y-axis) direction).

Accordingly, when the second lens module 220 moves in the second optical axis (Z-axis) direction, the position of the second lens module 220 may be detected using the third position sensor 672. In an example, the third position sensor 672 may be a Hall sensor.

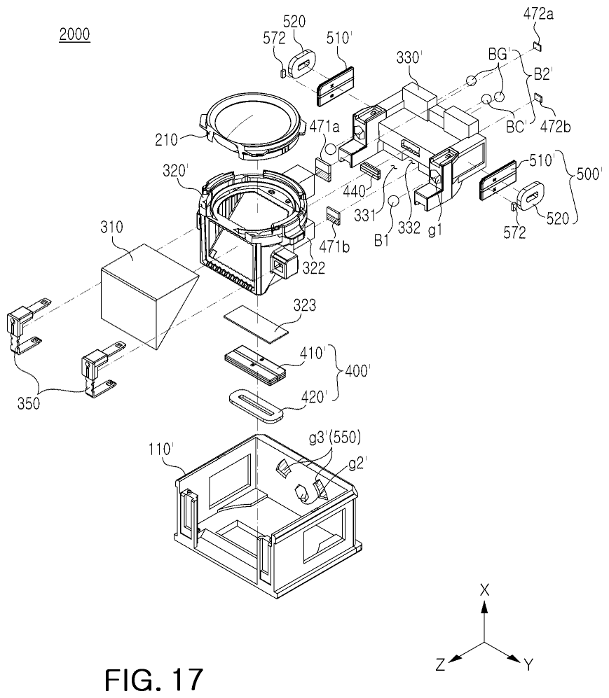

Hereinafter, a camera module 2000, according to another example embodiment, is described with reference to FIGS. 17 through 22.

The camera module 2000 in this example embodiment differs from the camera module 1000 described above in that a rotation axis of a guide member 330′ that implements the optical image stabilization (OIS) operation is different. Accordingly, a shape of a holder 320′, arrangement of a first magnet 410′ and a first coil 420′, disposition of a ball member B2′, a shape of a housing 110′, and the like may differ from those of the camera module 1000 described above. Therefore, in describing the camera module 2000 in this example embodiment, the description focuses on these differences, and other configurations may be commonly applied to the camera module 1000 described above. In describing this example embodiment, an X-axis, a Y-axis, and a Z-axis in the drawings may be defined as a third axis, a second axis, and a first axis, respectively.

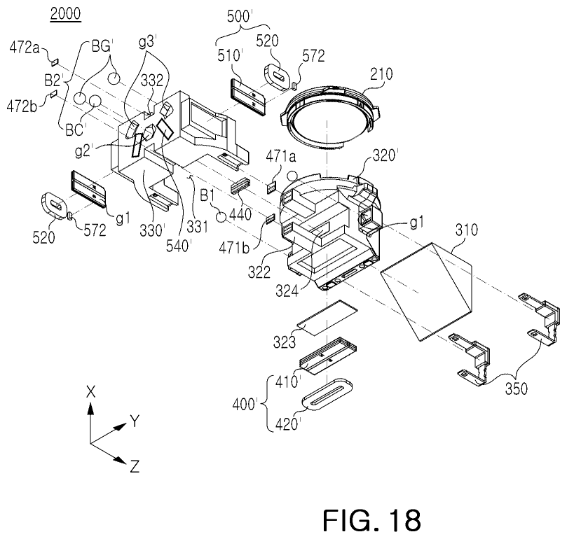

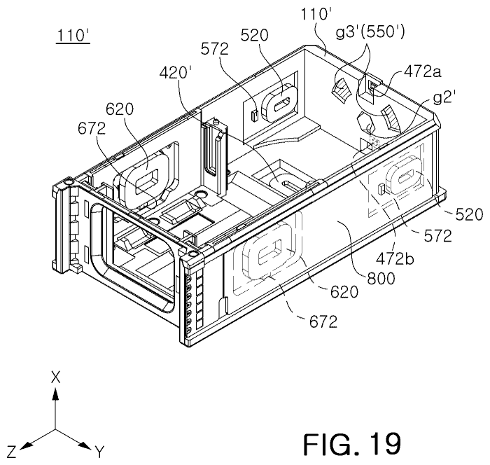

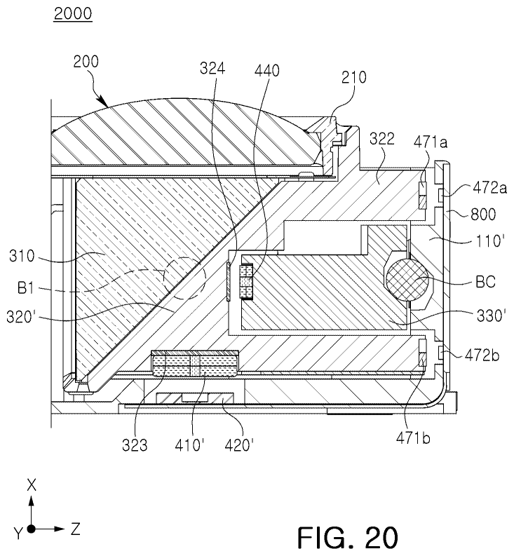

FIG. 17 is an exploded perspective view of the camera module 2000 according to another example embodiment. FIG. 18 is an exploded perspective view of the camera module 2000 illustrated in FIG. 17, which is viewed from another angle. FIG. 19 is a perspective view of the housing 110′ illustrated in FIG. 17. FIG. 20 is a view illustrating an X-Y cross section of the camera module 2000 according to another example embodiment.

Referring to FIGS. 17 and 20, the holder 320′ in which the first lens module 210 and the reflective member 310 are disposed may be rotatably supported by the guide member 330′.

In an example embodiment, the holder 320′ may be rotatably provided about a second axis (Y-axis) with respect to the guide member 330′. Accordingly, the plurality of first ball members B1 that support rotation of the holder 320′ about the second axis (Y-axis) may be disposed between the holder 320′ and the guide member 330′.

The first lens module 210 and the reflective member 310 may be disposed in the holder 320′, and may thus rotate together with the holder 320′ about the second axis (Y-axis).

The guide member 330′ may be rotatably supported by the housing 110′.

In an example embodiment, the guide member 330′ may be rotatably provided about a first axis (Z-axis) with respect to the housing 110′. Accordingly, a second ball member B2′ that supports a rotation of the guide member 330′ about the first axis (Z-axis) may be disposed between the guide member 330′ and the housing 110′.

The holder 320′ may be supported by the guide member 330′, and the holder 320′ may thus rotate together with the guide member 330′ about the first axis (Z-axis) when the guide member 330′ rotates. Accordingly, the first lens module 210 and the reflective member 310 disposed in the holder 320′ may also rotate together about the first axis (Z-axis).

The reflection module 300 may include a driving unit that generates a driving force to rotate the reflection module 300 about the first axis (Z-axis) and/or the second axis (Y-axis).

The driving unit may include magnets and coils, and may include a first driving unit 400′ that provides a driving force to the holder 320′ and a second driving unit 500′ that provides a driving force to the guide member 330′. In an example embodiment, the first driving unit 400′ may rotate the holder 320′ about the second axis (Y-axis), and the second driving unit 500′ may rotate the guide member 330′ about the first axis (Z-axis).

In an example embodiment, the driving force to rotate the reflection module 300 about the first axis (Z-axis) and/or the second axis (Y-axis) may be an electromagnetic force generated between the magnets and the coils.

The first driving unit 400′ may include the first magnet 410′ and the first coil 420′.

The first magnet 410′ may be disposed on a bottom surface of the holder 320′, and the first coil 420′ may be disposed on a bottom surface of the housing 110′ facing the bottom surface of the holder 320′.

A back yoke 323 may be disposed between the first magnet 410′ and the holder 320′. The back yoke 323 may be a portion of the holder 320′ and may be exposed through the bottom surface of the holder 320′. The first magnet 410′ may be disposed on the back yoke 323. The back yoke 323 may concentrate magnetic flux of the first magnet 410′ and prevent magnetic field leakage.

The first coil 420′ may be mounted on the substrate 800 and disposed on the bottom surface of the housing 110′, and may be exposed to an inner space of the housing 110′ through a through-hole formed in the bottom surface thereof.

The guide member 330′ may include an opening 331 that is open in a third axis (X-axis) direction, and the bottom surface of the holder 320′ may be disposed in the opening 331 while being supported by the guide member 330′.

Accordingly, the bottom surface of the holder 320′ may directly face the bottom surface of the housing 110′, and the first magnet 410′ disposed on the bottom surface of the holder 320′ and the first coil 420′ disposed on the bottom surface of the housing 110′ may thus face each other in the third axis (X-axis) direction.

The first magnet 410′ may have different polarities that are magnetized sequentially along a rotational direction. In an example, a surface of the first magnet 410′ facing the first coil 420′ may have the N pole (or the S pole), the neutral region, and S pole (or N pole) disposed sequentially along a rotational direction of the holder 320′, e.g., the third axis (Z-axis) direction. However, the configuration is not limited thereto, and the first magnet 410′ may also include a combination of one pair of unipolar magnets having different polarities. In this manner, when the first magnet 410′ includes the combination of one pair of unipolar magnets, the neutral region may be eliminated, thereby strengthening the driving force.

When power is applied to the first coil 420′, the first coil 420′ may interact with the first magnet 410′ to generate the driving force in a direction perpendicular to the direction in which the magnet and the coil face each other, for example, in the third axis (Z-axis) direction, and the holder 320′ may rotate about the second axis (Y-axis) by a resultant force of the driving forces.

In an example, the camera module 2000 in this example embodiment may include a first position sensing unit that detects the rotation of the holder 320′. The first position sensing unit may include a plurality of first sensing magnets 471a and 471b disposed on a surface of the holder 320′ facing the housing 110′ in the first axis (Z-axis) direction, and a plurality of first position sensors 472a and 472b disposed on the housing 110′. The plurality of first sensing magnets 471a and 471b and the plurality of first position sensors 472a and 472b may be disposed to face each other, respectively.

The plurality of first sensing magnets 471a and 471b may be aligned along the third axis (X-axis) and disposed symmetrically with respect to the second axis (Y-axis). Rotation driving of the holder 320′ about the second axis (Y-axis) may be accurately detected by disposing the plurality of first sensing magnets 471a and 471b symmetrically with respect to the second axis (Y-axis) and detecting a magnetic flux change through the plurality of first position sensors 472a and 472b.

Referring to FIGS. 17, 18, and 20, the first sensing magnets 471a and 471b may be disposed on a protrusion 322 included in the holder 320′. The protrusion 322 refers to a portion extending from the holder 320′ toward the guide member 330′ in the first axis (Z-axis) direction and may be disposed to pass through a concave part 332 formed in the guide member 330′.

In an example embodiment, the first position sensors 472a and 472b may be disposed on the substrate 800 and may face the first sensing magnets 471a and 471b through a through-hole formed in the housing 110′ in the first axis (Z-axis) direction.

The second driving unit 500′ may include a second magnet 510′ and the second coil 520.

In an example, the second magnet 510′ may be disposed on a side surface of the holder 330′, and the second coil 520 may be disposed on a side surface of the housing 110′ facing the side surface of the holder 330′.

In an example embodiment, the plurality of second magnets 510′ and the plurality of second coils 520 may be provided, respectively. That is, the second magnets 510′ may be disposed on both side surfaces of the holder 330′, and the second coils 520 may be disposed on both side surfaces of the housing 110′ facing the both side surfaces of the holder 330′.

The second coils 520 may be mounted on the substrate 800, and may be disposed on both of the side surfaces of the housing 110′, and may be exposed to the inner space of the housing 110′ through through-holes respectively formed in the both side surfaces thereof.

In an example embodiment, the second magnets 510′ may include two magnets, and the second coils 520 may include two coils. The magnet and the coil may face each other in the second axis (Y-axis) direction while being separately disposed on each of two side surfaces of the guide member 330′ and the housing 110′.

The second magnet 510′ may have different polarities magnetized sequentially along the rotational direction. A surface of the second magnet 510′ facing the second coil 520 may have the N pole (or S pole), the neutral region, and the S pole (or N pole) sequentially along a rotational direction of the guide member 330′, e.g., the third axis (X-axis) direction. However, the configuration is not limited thereto, and the second magnet 510′ may also include a combination of one pair of unipolar magnets having different polarities. In this manner, when the second magnet 510′ includes the combination of one pair of unipolar magnets, the neutral region may be eliminated, thereby strengthening the driving force.

When power is applied to the second coil 520, the second coil 520 may interact with the second magnet 510′ to generate the driving force in a direction perpendicular to the direction in which the magnet and the coil face each other, for example, in the third axis (X-axis) direction, and the guide member 330′ may rotate about the first axis (Z-axis) by a resultant force of the driving forces.

Referring to FIG. 19, the housing 110′ may include a plurality of guide grooves g2′ and g3′ for accommodating a portion of the second ball member B2′ disposed between the housing 110′ and the reflection module 300.

In an example embodiment, the plurality of guide grooves g2′ and g3′ may be formed on one side surface of the housing 110′ perpendicular to a longitudinal direction (Z-axis direction).

The plurality of second ball members B2′ may be disposed in the plurality of guide grooves g2′ and g3′, and the reflection module 300 may be supported by the housing 110′ in the third axis (Z-axis) direction while having the second ball members B2 therebetween.

The second guide groove g2′ may accommodate at least a portion of a center ball BC′ and may have three inclined surfaces for three-point support of the center ball BC′. However, the configuration is not limited thereto, and the second guide groove g2′ may also have a concave shape along a circular inclined surface.

The center ball BC′ may form the first axis (Z-axis) while rotating in place while being accommodated in the second guide groove g2′.

The third guide groove g3′ may accommodate at least a portion of a guide ball BG′ and may be provided in the same number as the guide balls BG′, e.g., two.

The third guide groove g3′ may extend in a circumferential direction around the center ball BC′. However, the configuration is not limited thereto, and the third guide groove g3′ may have various shapes such as rectangular or circular, as long as an area sufficient for movement of the guide balls BG′ is secured.

In an example, a pulling yoke 550′ corresponding to a magnetic material may be inserted into the third guide groove g3′, and a magnetic attractive force may thus act between the pulling yoke 550′ and a pulling magnet 540′ mounted on the guide member 330′.

The housing 110′ may include the plurality of through-holes passing through the side surfaces or bottom surface thereof. Some of the driving unit for driving the reflection module 300 or the second lens module 220, for example, coils, position sensors, and the image sensor module 700, may be disposed in the plurality of through-holes.

The substrate 800 on which the coils and the like are mounted may be disposed on the housing 110′. The substrate 800 may be disposed to cover three side surfaces and a portion of the bottom surface of the housing 110′ from the outside thereof. In an example, the coils and the like mounted on the substrate 800 may be exposed to an inner space of the housing 110′ through the through-holes formed therein.

In an example embodiment, portions of the substrate 800 disposed on different surfaces of the housing 110′ may all be integrally formed, and in this example, at least a portion of the substrate 800 may be made of a flexible material. However, the configuration is not limited thereto, and the substrate 800 may be divided into a plurality of parts and provided.

Referring to FIG. 20, to prevent separation of the first ball member B1, the holder 320′ may be supported by the guide member 330′ in the first axis (Z-axis) direction while having the first ball member B1 therebetween.

Additionally, one pair of magnetic materials 324 and 440 may be disposed to face each other in the first axis (Z-axis) direction between the holder 320′ and the guide member 330′.

In an example embodiment, one pair of magnetic materials 324 and 440 may include the pulling yoke (or first magnetic material) 324 disposed on the holder 320′ and the pulling magnet (or second magnetic material) 440 disposed on the guide member 330′.

The pulling yoke 324 and the pulling magnet 440 may generate magnetic attractive force in a direction in which the pulling yoke 324 and the pulling magnet 440 face each other, that is, the first axis (Z-axis) direction. By the magnetic attractive force generated therebetween, the holder 320′ may be closely supported by the guide member 330′ while having the first ball member B1 therebetween.

In another example embodiment, positions of the pair of magnetic materials 324 and 440 described above may be interchanged. Additionally, in another example embodiment, another type of magnetic interaction (e.g., magnetic repulsion) may act between the pair of magnetic materials 324 and 440 described above.

In an example embodiment, the first position sensors 472a and 472b may be mounted on the substrate 800 and disposed on the housing 110′, and may face the first sensing magnets 471a and 471b through the through-hole. The first position sensors 472a and 472b may face the neutral regions of the first sensing magnets 471a and 471b.

The first position sensors 472a and 472b may be magnetic sensors to detect an amount of movement of the first sensing magnets 471a and 471b through magnetic flux changes thereof. The first position sensors 472a and 472b may be disposed to face the neutral regions of the first sensing magnets 471a and 471b, thereby effectively detecting the magnetic flux changes.

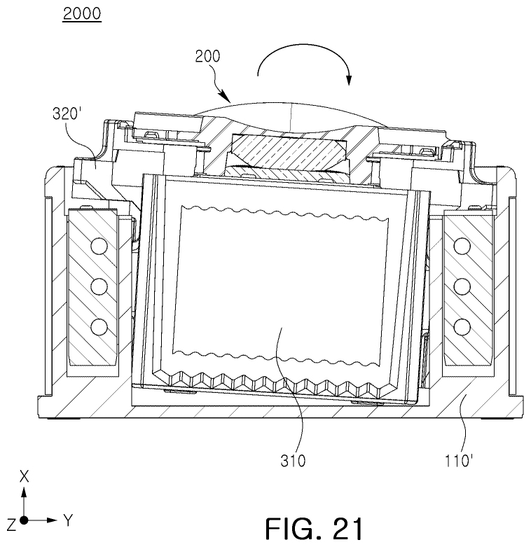

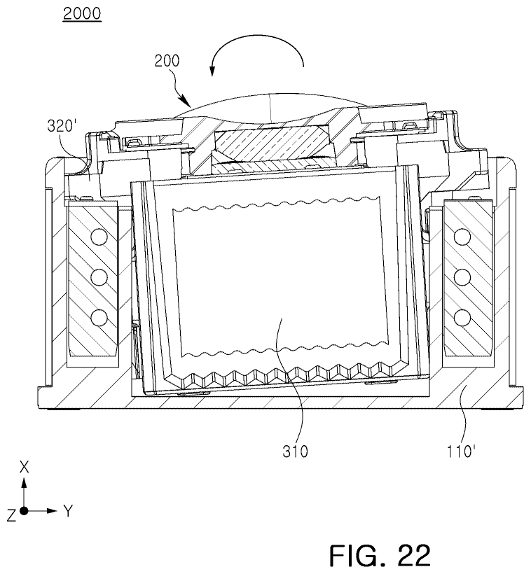

FIGS. 21 and 22 are views illustrating rotation driving of the holder 330′ included in the camera module 2000 according to another example embodiment.

Referring to FIGS. 21 and 22, the guide member 330′ may rotate about the first axis (Z-axis) with respect to the housing 110′ by electromagnetic interaction between the second magnets 510′ and the second coils 520. As the guide member 330′ rotates about the first axis (Z-axis), the holder 330′ supported by the guide member 330′ may also rotate about the first axis (Z-axis) together.

As set forth above, the reflection module and the camera module including the same according to an example embodiment may have the improved sensitivity and linearity of position sensing for the rotating reflective member.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A reflection module, comprising:
a housing;
a guide member, disposed on the housing, and configured to rotate about a first rotation axis;
a holder, comprising a reflective member, and configured to rotate, with respect to the guide member, about a second rotation axis, perpendicular to the first rotation axis;
a first driving unit comprising a first magnet disposed on the holder and a first coil disposed on the housing to face the first magnet; and
at least one pair of position sensors disposed on one surface of the housing,
wherein position sensors of the at least one pair of position sensors are disposed symmetrically with respect to a center of the first coil.

2. The reflection module according to claim 1, wherein the at least one pair of position sensors is disposed in a direction parallel to the first rotation axis.

3. The reflection module according to claim 2, wherein each of the position sensors is disposed to be spaced apart from the center of the first coil in the direction parallel to the first rotation axis.

4. The reflection module according to claim 1, wherein, based on an imaginary plane perpendicular to the first rotation axis and including the second rotation axis, a number of first position sensors facing a first side of the imaginary plane is equal to a number of first position sensors facing a second side of the imaginary plane among the at least one pair of position sensors.

5. The reflection module according to claim 4, wherein a distance between the position sensors facing the first side of the imaginary plane and the imaginary plane is equal to a distance between the position sensors facing the second side of the imaginary plane and the imaginary plane.

6. The reflection module according to claim 1, further comprising at least one pair of first sensing magnets disposed on the holder, and the at least one pair of first sensing magnets faces the at least one pair of position sensors.

7. The reflection module according to claim 6, wherein a position sensing unit, which comprises the at least one pair of position sensors and the first sensing magnets, is configured to sum sensing results received from the respective position sensors of the at least one pair of position sensors.

8. The reflection module according to claim 6, wherein each of the first magnet of the first driving unit and the first sensing magnet has two polarities disposed in a direction parallel to the first rotation axis, and
a region where the first magnet of the first driving unit and the first sensing magnet face each other has a same polarity.

9. The reflection module according to claim 1, wherein the at least one pair of position sensors is disposed in a direction parallel to the second rotation axis.

10. The reflection module according to claim 9, wherein an imaginary plane perpendicular to the first rotation axis and including the second rotation axis passes through the at least one pair of position sensors.

11. The reflection module according to claim 1, further comprising a first ball member disposed between the holder and the guide member and comprising a plurality of balls that are spaced apart from each other along the second rotation axis.

12. The reflection module according to claim 1, further comprising a second driving unit comprising second magnets respectively disposed on respective side surfaces of the guide member and second coils disposed on the housing to face the second magnets,
wherein the respective side surfaces of the guide member are perpendicular to the second rotation axis.

13. The reflection module according to claim 11, comprising a second ball member disposed between the guide member and the housing, the second ball member comprising a center ball that forms the first rotation axis and guide balls that supports the guide member.

14. A camera module, comprising:
a holder on which a reflective member is mounted;
a guide member on which the holder is disposed and which is configured to rotate, together with the holder, about a first rotation axis;
a housing which accommodates the holder and the guide member;
a lens module through which light reflected from the reflective member passes in an optical axis direction;
a first driving unit comprising a first magnet mounted on the holder and a first coil which faces the first magnet in the optical axis direction; and
at least one pair of position sensors disposed on one surface of the housing,
wherein the holder is configured to rotate, relative to the guide member, about a second rotation axis, perpendicular to the first rotation axis, and
wherein the position sensors of the at least one pair of first position sensors are disposed symmetrically with respect to an imaginary center line which extends along an optical axis.

15. The camera module according to claim 14, wherein each of the position sensors is disposed to be spaced apart from the imaginary center line in a direction parallel to the first rotation axis.

16. The camera module according to claim 15, wherein a shortest distance between each of the first position sensors and the imaginary center line is equal to each other.

17. A camera module, comprising:
a housing;
a guide member, disposed on the housing, and configured to rotate about a first axis;
a holder, comprising a reflective member, and configured to rotate, with respect to the guide member, about a second axis perpendicular to the first axis; and
a first position sensing unit configured to detect a rotation of the holder,
wherein the first position sensing unit comprises:
a plurality of first sensing magnets disposed on a surface of the holder which faces the housing in a first axis direction, and
a plurality of position sensors disposed on the housing to respectively face the plurality of first sensing magnets.

18. The camera module according to claim 17, wherein at least one of the plurality of first sensing magnets comprise a combination of a pair of unipolar magnets which have different polarities.

19. The camera module according to claim 17, wherein the plurality of first sensing magnets are aligned along a third axis which is perpendicular to the first axis and the second axis, and disposed symmetrically with respect to the second axis.

20. The camera module according to claim 17, wherein the holder comprises a protrusion which extends toward the guide member in the first axis direction,
wherein the guide member comprises an opening through which at least a portion of the protrusion passes, and
wherein the first sensing magnets are disposed on the protrusion.

21. The camera module according to claim 19, further comprising a first driving unit configured to provide a driving force to the holder,
wherein the first driving unit comprises a first magnet disposed on a surface of the holder which faces the housing in a third axis direction, and a first coil disposed to face the first magnet.

22. The camera module according to claim 21, wherein the first magnet comprises a combination of a pair of unipolar magnets which have different polarities.

23. The camera module according to claim 17, further comprising a second driving unit configured to provide a driving force to the guide member,
wherein the second driving unit comprises a second magnet disposed on a surface of the guide member which faces the housing in a second axis direction and a second coil disposed to face the second magnet.

24. The camera module according to claim 23, wherein the second magnet comprises a combination of a pair of unipolar magnets which have different polarities.

25. The camera module according to claim 23, further comprising a plurality of ball members disposed between the guide member and the housing,
wherein the plurality of ball members comprise a center ball positioned on the first axis and a plurality of guide balls which support a rotation of the guide member.
